(19) United States
(12) Patent Application Publication
(10) Pub. No.: US 2009/0157434 A1
(43) Pub. Date: Jun. 18, 2009

(54) STRUCTURING BONDS AND/OR OTHER SECURITIES COLLATERALIZED BY INSURANCE POLICIES

(76) Inventors: James J. Darr, Greenwich, CT (US); Andrew S. Benjamin, Princeton Junction, NJ (US)

Correspondence Address: PATTON BOGGS LLP, 8484 WESTPARK DRIVE, SUITE 900, MCLEAN, VA, 22102, US

(21) Appl. No.: 12/331,198

(22) Filed: Dec. 9, 2008

Related U.S. Application Data
(60) Provisional application No. 60/996,989, filed on Dec. 13, 2007.

(51) Int. Cl. G06Q 40/00

(52) U.S. Cl. 705/4

(57) ABSTRACT

Systems, computer program products and methods of collateralizing bonds and/or other securities using one or more insurance policies are described. A method may include receiving input regarding an appropriate grouping from a collection of one or more insureds, receiving input regarding an initial value for a face amount of one or more insurance policies, one or more mortality curves for calculating a single premium and a mortality expectation table for determining a presumed mortality expectation, receiving information regarding the one or more insurance policies, and receiving information regarding an insurer's assumptions and outcomes. The various inputs may be processed. The results of the processing may be output in the form of expected cash flow and timing. Associated data processing systems and computer program products are also described.

### CROSS-REFERENCE TO RELATED APPLICATION

This application claims priority to U.S. Provisional Patent Application Ser. No. 60/996,989, filed Dec. 13, 2007, the contents of which are incorporated by reference herein in their entirety.

### FIELD OF THE INVENTION

The present invention is broadly directed to securitized investments and generally directed to insurance products, methods and related systems. More particularly, it is directed to tranching and otherwise structuring bonds and/or other securities collateralized by one or more insurance policies.

### BACKGROUND OF THE INVENTION

In the following discussion certain articles and methods will be described for background and introductory purposes. Nothing contained herein is to be construed as an “admission” of prior art. Applicant expressly reserves the right to demonstrate, where appropriate, that the articles and methods referenced herein do not constitute prior art under the applicable statutory provisions.

There are many forms of life insurance available on the market. One such form of insurance is often referred to as a “variable universal life insurance policy”. This type of policy often has flexible premiums and an adjustable death benefit. The cash values and death proceeds are usually linked to the investment results and expenses of the company that issued the policy.

While most purchase an insurance policy to preserve their family's financial security, these financial products have a number of other uses. One such use is within a charitable fundraising system or method for charitable and/or non-profit organizations (“NPOs”). Commonly-owned International Patent Application Serial Nos. PCT/US2005/08102 and PCT/US2006/02977, as well as commonly owned U.S. patent application Ser. Nos. 10/382,947, 10/798,551, and 11/193,330 disclose such systems or methods. The content of these disclosures are incorporated herein by reference in their entireties for their discussion of fundraising as well as all other aspects that they disclose.

Of particular interest are methods that generally involve a supporter, or group of supporters, who agree to be insured by and/or for the benefit of an organization, and who assign their rights in the policies to the organization. The organization may hold the policies in a passive vehicle. A lender may provide capital to the organization in the form of a loan that is secured by the policies. The lender may be repaid from the proceeds of the policies via the passive vehicle. In this manner, the donor or group of donors can, with a limited investment, provide a stream of funding to accomplish a purpose in the organization during the donor's lifetime. In addition, an organization can market a particular purpose fund to a number of potential benefactors who can each participate for a limited contribution.

In structured finance, the word ‘tranche’ refers to one or more related securitized bonds and/or other securities offered as part of a deal. For example, collateralized mortgage obligations are structured with one or more tranches of bonds and/or other securities that may have various maturities. A securitized bond and/or other security may be split into several tranches, where the combination of all of the tranches makes up a capital structure or liability structure. Tranches are generally paid sequentially from the most senior to most subordinate. The more senior rated tranches generally have higher ratings than the lower rated subordinate tranches. A single tranche may be a note issued where in addition to the credit risk of the issuing entity; the investors take credit risk on a portfolio of entities.

Tranching has inherent risks. Tranching can add complexity to deals including documentation to ensure that the desired characteristics, such as the seniority ordering the various tranches, will be delivered under all plausible scenarios. In addition, complexity may be further increased by the need to account for the involvement of asset managers and other third parties, whose own incentives to act in the interest of some investor classes at the expense of other may need to be balanced.

In contrast, however, tranching may have various benefits. For example, tranches may allow for an ability to create one or more classes of securities whose rating is higher than the average rating of the underlying collateral asset pool or to generate rated securities from a pool of unrated assets. This is accomplished through the use of credit support specified within the transaction structure to create securities with different risk-return profiles. Due to the credit support resulting from tranching, the most senior claims are expected to be insulated from default risk of the underlying asset pool through the absorption of losses by the more junior claims. Tranching may also allow investors to further diversify their portfolio or be presented with various maturity options that may be unavailable from a single issuance of the underlying investment.

Despite the drawbacks of tranching, there are many possible benefits to organizations, such as charitable organizations, nonprofit organizations (“NPOs”), investors or others, which may use tranching to create a more guaranteed cash flow.

Needs exist for insurance products and methods structured to provide advantages over current products and methods, and, in particular, which are structured to maximize performance of bonds and/or other securities collateralized by one or more insurance policies. There is also a need for data processing methods and systems for accurately administering such products in a time-efficient and accurate manner.

### SUMMARY OF THE INVENTION

It is, therefore, an object of certain embodiments of this invention to provide insurance products, methods and/or systems having beneficial features that make them optimal for use in certain situations, such as incorporation into a method for tranching bonds and/or other securities and collateralizing bonds and/or other securities with one or more insurance policies. According to certain alternative embodiments of the present invention, such methods for raising funds may optionally involve one or more supporters who consent to be insured by, and/or for the benefit of, a charitable organization or NPO or other entity with an insurable interest in the supporter(s), and who grant whatever rights they may be deemed to have in the insurance product to the charitable organization or NPO. It is also an objective of the present invention to provide data processing methods and systems for accurately administering such products in a time-efficient manner.

According to one aspect of the present invention, there may be provided a computer program product stored in a computer useable medium for structuring at least one of bonds and other securities collateralized with one or more life insurance policies, the computer program product performing steps including: receiving input regarding an appropriate grouping of insureds from a collection of one or more insureds; receiving input regarding an initial value for (1) a face amount of one or more insurance policies, (2) one or more mortality curves for calculating a single premium, and (3) a mortality expectation table for determining a presumed mortality expectation; receiving inputs regarding the one or more insurance policies; receiving inputs regarding an insurer's assumptions and outcomes; processing the inputs; and outputting results of the processing in the form of an expected cash flow and timing.

Embodiments of the present invention may further include inputting a set of desired tranches wherein the set of desired tranches comprises information regarding a year of payment, an implied interest rate, and a percentage of projected available cash flow and portion of the projected available mortality made available to each individual tranche, altering the set of desired tranches, processing the set of desired tranches and/or outputting an analysis of the set of desired tranches wherein the outputting includes a single annual rate at which each individual tranche is fully repaid while leaving a remaining residual of zero. Alternatives may exist where a residual is not equal to zero. Calculations may include determining the rate or rates of return required for a given tranche. Calculations may use the available projected mortality and a minimum rate passed through to all future tranches at which all principal is returned without investor capital loss. The residual may be reinvested or otherwise utilized.

In embodiments of the present invention, the one or more insureds may consent to be insured and assign all rights in the insurance policy to a non-profit or charitable organization, a supporting organization of the non-profit or charitable organization, or an entity with insurable interest rights.

Embodiments of the present invention may also include a data processing system for initiating, structuring and managing at least one of bonds and other securities collateralized by one or more insurance policies, the data processing system including: an input device; wherein the input device receives input from a user regarding (1) an appropriate grouping of insureds from a collection of one or more insureds, (2) an initial value for a face amount of one or more insurance policies, (3) one or more mortality curves for calculating a single premium, (4) a mortality expectation table for calculating the presumed mortality expectation, (5) the one or more insurance policies, and (6) an insurer's assumptions and outcomes; a data processing device comprising a processor and a memory; wherein the data processing device accepts the input and calculates an expected cash flow and timing; an output device; and wherein the output device outputs the results of the calculating. If embodiments of the present invention are operated within a spreadsheet, a number of different algorithms or macros may be utilized, preferably implemented by the computer. These algorithms or macros are contemplated to be within the scope of certain embodiments of the invention.

In embodiments of the present invention, the collection of one or more insureds is an actual collection of males and females of various ages or a prospective collection of males and females of various ages. The initial value for a face amount may be $250,000 per life. The input device further may receive input regarding separate account yields and expenses wherein the separate account yields and expenses comprise a gross earning rate, an asset management fee, spread fees, and earnings outside separate account. The insurer's assumptions and outcomes may include variables set forth in the insurance policy structure. The data processing device may output a value to the organization paying the premiums on the one or more insurance policies.

In embodiments of the present invention, the input device may further accept input from the user regarding a desired set of tranches. The data processing device may further output a break even gross earnings rate for covering repayment of the desired set of tranches with a minimal residual value, a check of whether a given gross interest rate fully repays each debt tranche and has a minimal residual value, a weighted average yield of the desired set of tranches, and/or a complete break even rate needed to fully repay the desired set of tranches. Calculations of income streams may be performed using a correlated path of equity and debt returns given a stated mix of equities and bonds; the yields may be fixed or varied based on a given or historical mean returns, standard deviations and correlation between investment types. The input device may further accept changes to the desired set of tranches.

Embodiments of the present invention may also include a computer program product stored in a computer useable medium for structuring at least one of bonds and other securities collateralized by one or more insurance policies, the computer program product including: a module for accepting input regarding a collection of insureds: a module for accepting input regarding insurance policy structure and variables; a module for accepting input regarding insurance company policies and variables; a module for accepting input regarding insurance policy beneficiary assumptions and variables; a module for accepting input regarding a desired set of tranches; a module for processing the inputs to determine an expected cash flow and timing; and a module for outputting the results of the processing.

Certain portions of this invention may be performed outside of the United States and enrollee commitments data, computations, and/or analysis is transmitted all or in part into the U.S. Alternatively, portions of this invention may be performed in the U.S. and enrollee commitments data, computations and/or analysis is transmitted—all or in part—outside of the U.S. Thus, the export or import enrollee commitments data, computations, and/or analysis are contemplated as an embodiment of the present invention.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 is a schematic illustration of a system, method and data processing device according to the principles of the present invention.

### DETAILED DESCRIPTION OF THE INVENTION

An insurance product and its associated methods and systems may be structured to comprise one or more of the following characteristics. Bonds and/or other securities may be separated into tranches based upon underlying insurance policies.

A prospective insured may provide consent to be insured and may meet minimum standards of good health, which may vary and are to be determined at the discretion of the insurer and/or administrator of the program. To be eligible for coverage, at policy issue an insured should optionally be at least age 21, and preferably not older than 65.

According to one embodiment, a policy covering each individual may be structured to have an initial death benefit of, for example, $250,000. Other amounts may be used. The individual policies may be aggregated into pools and/or into a single group policy. The number of policies in the pool(s) and/or group policy may vary. For example, one or more pools and/or a group policy of approximately 1,000 lives or more may be formed. The policies may be structured to qualify as an insurance contract under U.S. tax law.

The policy may generally comprise a group flexible premium, adjustable death benefit, variable universal life insurance policy. Death benefits may be made payable upon the death of an insured prior to age 100. The insurance company may guarantee death benefits as long as the policy remains in force. Cash values may be made payable to the owner and/or beneficiary and/or designee upon policy termination or upon the insured living to age 100. Premium payments may be flexible as to timing and amount, subject to minimum and maximum limitations, but it is expected that the policies may be funded by a single premium. All values and benefits of the policy may be based upon investment performance of a separate account(s), which may be variable and may not be guaranteed. According to one optional embodiment, the policy may be structured as a Modified Endowment Contract (“MEC”). The MEC may be funded with a single premium, although the single premium can be paid with one or more payments.

Qualified non-profit organizations or other entities with an insurable interest in the insureds in or outside of the US, including but not limited to educational, religious and charitable organizations can be responsible for premium payments, may designate itself as the beneficiary of policy benefits or name another beneficiary, have the right to direct the allocation of assets among the separate account(s), or appoint an entity or assignee to direct allocation of assets. There may or may not be any restrictions on the NPOs and/or other entities ability to transfer rights of ownership to other parties.

According to certain embodiments of the present invention, the premium may comprise a single lump sum. The policy owner may make a single, one-time payment at issuance of the policy. Alternatively, the premium may be paid in multiple installments. The amount of the premium may be determined by any suitable methodology, such as utilizing actuarial tables like the 1980 Commissioner's Standard Ordinary Male and Female Tables, each insured's age at their nearest birthday, and 4% interest.

According to the principles of the present invention, the charitable or non-profit organization, a supporting organization of the charitable or non-profit organization, an entity with insurable interest rights, or an agent thereof, may be responsible for payment of the premium. The supporting organizations, entities with insurable interest rights, or agents thereof may or may not be necessarily be controlled by the charitable or non-profit organization. The supporting organization, entity with insurable interest rights, or agents thereof may or may not be based in the United States or its territories.

According to certain aspects of the present invention, an NPO and/or other entity with an insurable interest in the insureds may pay the premium by making an initial payment of, for example, $1,000 to initiate policy and coverage on a block of lives with remainder of the premium being paid by a separate installment(s) due within a set period of time, such as 5-10 business days. If premium is not paid, the policy may be retroactively canceled and the insurer is not liable for any payments. Once full payment is made, the policy may be effective as of the date of the initial payment. Any deaths that may have occurred after the payment date may be payable by the insurer. When utilized within the United States, the policy may optionally be a MEC pursuant to the requirements of Internal Revenue Code Section 7702 for U.S. Federal Income Tax purposes. Additional premiums may not be required if the policy cash value is sufficient to cover expenses and cost of insurance for the year. Depending upon the investment performance of the underlying separate account, future premiums may be required to be paid to keep the policy in full force.

As noted above, death benefits may increase or decrease with the underlying performance of the separate account. Preferably, death benefits may be increased to comply with the cash value accumulation test or corridor test under section 7702 of the United States Internal Revenue Code. Cash value accumulation test factors may be based on the same mortality and interest assumptions used to determine the premium, and the insured's age at determination.

Embodiments of the present invention may include a method and system for collateralizing bonds and/or other securities with insurance products. The method and system may be implemented in a spreadsheet, data structure or other similar format. The spreadsheet or data structure may be input driven and result in an output of expected cash flows and timing based on the input. The results of the tranching and structuring may be embodied in electronic form or in a tangible, hard copy.

If embodiments of the present invention are operated within a spreadsheet, macros and/or software modules may be required. Each operation described herein may be carried out by one or more computer program product modules. Macros may be required to correctly calculate the ‘break even’ yield needed for the bond section as well as to calculate a Monte Carlo return result from a user defined number of iterations given a set of yield inputs, correlations and mean returns. Macros may also be required for printing and other operations.

The method of the present invention may allow for pool of lives and/or lives in a group policy configuration and testing, mortality analysis and testing, separate account modeling and analysis, and/or asset-backed security configuration and testing.

Pool of lives or lives in a group policy configuration and testing may be accomplished by inputting required and/or optional information into the method, system or spreadsheet. If a spreadsheet format is used for a particular embodiment of the present invention, the spreadsheet may be set up with a number of input forms arranged by areas of interest and/or ownership.

The following are potential examples of input forms or schedules that can be used in some of the embodiments of this invention. Other input forms or schedules are contemplated to perform variations on the exemplary embodiment below.

Pool Grid: This schedule may allow entry of a predetermined actual or prospective collection of males and females of various ages that in total becomes the pool for the group life insurance policy. The initial death benefit amount per age group may also be set here if it varies from a default. All appropriate combinations may be allowed.

Pool Assumptions—Grid: This schedule may allow for the setting of variables which affect the premium calculation and separate account performance. Variables may include:

(1) Selection of mortality table for use in determining the initial premium for the Policy. The 1980 CSO may be the default table used.

(2) Selection of mortality table for use in determining the presumed mortality expectation. Allowable tables for premium selection and mortality expectations may include: 1993 GAM, 1994 GAM, 1980 CSO, 75-80 Ult, 2001 VBT Ultimate, 2001 VBT Select, 2008 VBT Ultimate, 2008 VBT Select and RP2000, and other appropriate tables. For the 2001 and 2008 VBT tables, a synthetic table may be created utilizing a selected percentage of smokers and non-smokers. A mortality multiplier other than 1.00 may be additionally selected to alter the speed of mortality—either faster than or slower than the baseline 1.0. The method and system of the present invention may be readily extensible to allow for additional tables.

(3) Separate account yields and expenses may also be selected. Examples of separate account yields and expenses may include: Gross Earning Rate (the actual investment performance); Asset Management Fee (expense to the Gross Earnings Rate expressed in basis points); Insurance Company Spread Fee (expense to the Gross Earnings Rate); and/or Earnings Outside Separate Account (calculated as the Gross Earnings Rate less the Asset Management Fee). Yield rates may be fixed or variable during the model period.

Insurance Co Assumptions: This schedule may allow variables to be set that are part of the policy structure itself and/or under the control of the insurance company. These variables may include a grid of mortality charges, per life expenses and setup charges.

Assumptions and Outcome: This schedule may show the variables that affect the NPO or other organization and allow a calculation showing the value of the trade to the NPO and/or another organization. The calculation may determine the NPOs and/or another organization's net proceeds after taking into account the negotiated spread the NPO and/or another organization would receive from the separate account over time and discounting that value from the presumed mortality performance. The method of the present invention may allow for entry of NPO and/or another organization's costs, administration fee, any applicable excise tax and the calculated single premium costs. The separate account performance may be as calculated in the pool assumptions schedule.

Administration Assumptions: This schedule may allow for the tranching of zero coupon bonds and/or other securities at various rates, duration and effective allocation of available proceeds. This schedule may also calculate the remaining residual for non-complete allocations of available proceeds. This schedule may also show the outcome of a calculation to determine breakeven gross earnings rate needed to cover the repayment of the zero coupon bonds and/or other securities with the least amount of residual value.

Administration Zeros Break Even (“BE”) Check: This schedule may be used to check whether a given gross interest rate fully repays each debt tranche and has the lowest possible residual value. A Visual Basic or other similar macro may be used to solve for the optimal interest rate.

Grid Operating: This schedule may show the consolidation of cash flows for each age/sex combination in the grid of lives. All of the individual calculations may be performed elsewhere in the spreadsheet or other implementation.

Grid BE Yields: This schedule, also a consolidated schedule, may be identical to Grid Operating schedule with an exception of an underlying gross earnings rate used for interest calculations. The gross earnings rate may be derived from the break even calculation.

Administration Zeros: This schedule may compound the annual cash flows from the Grid Operating schedule at an ‘earnings outside separate account’ rate. All additions may be shown, due to the design of the policy, as end of year deposits (no interest is added on new additions in the year of the deposit). A lookup table may be used to check the period in which each of the zero coupon tranches matures and these amounts may be subtracted from the balance. Any remaining funds may be carried forward to the next year. The present invention may also calculate the success/failure of the bond and/or other security repayment under the assumption that all available funds are used to repay a tranche when due, i.e., the present invention may show what happens if there are no funds carried forward to future years. This may be identical to the net yield up to the point of a tranche due date being exactly the break even rate. The weighted average yield of all of the tranches may also be calculated on this schedule.

Administration Zeros Break Even: This schedule may calculate the complete break even rate needed to fully repay the bond and/or other security tranches. The present invention may assume that funds are still carried forward, but that the residual after full repayment of all tranches is as close as possible to $0. The calculations on this schedule may rely on input and/or calculations from other schedules, such as the Zeros BE Check and Administration Assumptions schedules as described previously.

Mortality Calculations: This schedule, preferably using the inputs on mortality table selections, may show the various expected mortality rates for the Grid Operating or other relevant schedules and related supporting schedules.

Male Single Premium Calculator: This schedule may calculate, for each age group of men, the single premium payment as a percentage of face. It may use the mortality table selection from the Pool Assumptions—Grid schedule.

Female Single Premium Calculator: This schedule may be identical to the Male version but calculate for each age group of women.

Mortality Experience Tables: These tables may be source data for the various mortality expectations available within the present invention. This may be standard industry data.

Male Composite: This table may include industry data for male tables that may include 1993 GAM, 1994 GAM, 1980 CSO, 75-80 Ult, 2001 VBT Ultimate, 2001 VBT Select, 2008 VBT Ultimate, 2008 VBT Select and RP2000, and other appropriate tables.

Female Composite: This table may have an identical setup to the male version except using female data.

Male Lives Buildout: This schedule may be where some or most of the intensive calculations are performed for all males in the pool. Each column in a spreadsheet format may represent an age group. A lookup may be performed to identify how many of a particular age group have been selected to be in the group and the starting death benefit for each group. A column may be divided into sections that reflect the setup and calculations performed in a Grid Operating or similar schedule. The calculations may use VBT and/or other actuarial table's mortality curves that vary by age; the curves change based on the starting age used. The model may calculate each of the relevant curves for each age group.

Female Lives Buildout: A schedule matching the Male Lives Buildout schedule except using the female curves in place of the male versions.

BE—Male Lives Buildout: This schedule may be the same as the Male Lives Buildout, with the exception of the interest rates used on the separate account. This schedule may pick up and use the break even (“BE”) rate to create and check the break even schedules.

BE—Female Lives Buildout: This schedule may be a female version of the BE—Male Lives Buildout.

Embodiments of the present invention may include methods, computer program products stored in a tangible medium, computer programs stored in memory and executed by one or more processors, systems and/or spreadsheets that are easily and readily accessible to a user. Interfaces may be designed to facilitate efficient operation of the present invention.

Embodiments of the present invention may include a method, computer program product or system for collateralizing bonds and/or other securities through insurance policies. To operate the method of the present invention, a user may first select an appropriate test group. Selection and other steps are preferably performed through a computer program product. Information may be stored and/or processed by a data structure. Input electronic signals may be transformed by processing or storing in the data structures. Electronic signals may also be transformed by displaying inputs and/or outputs to a user. Alternatively, a user may key in an actual group of individuals. This group may be made by selecting the number of males and/or females of various ages present in a particular collection of individuals. A total count of the selection may be maintained. A policy in accordance with embodiments of the present invention may optimally be designed for a minimum of 1,000 lives. Other quantities may be possible.

The user may then select an initial face amount. A default value of $250,000 per life may be selected. Other values are contemplated and may be input. Also selected may be mortality curves for calculating a single premium and mortality expectation. The default mortality curve for calculating a single premium may be the 1980 CSO, but other mortality curves may be input or selected. The default mortality expectation may be 1993 GAM, 1994 GAM, 1980 CSO, 75-80 Ult, 2001 VBT Ultimate, 2001 VBT Select, 2008 VBT Ultimate, 2008 VBT Select or RP2000, but other mortality expectations may be input or selected. The model may show a warning if a non-default choice is made for pricing the premium.

The user may next be given an opportunity to amend the defaults on the policy and insurance company side of the equation. Without a change to the structure of the insurance product, changes to this schedule may be unlikely or unwarranted.

The user may then edit NPO and/or other organization's assumptions and outcomes. Changes to this section may be the result of negotiations or indications from the NPO(s) and/or other organizations involved in the transaction.

The method of the present invention may then output a result of calculations in the form of cash flow and timing. Cash flows and timing may be calculated and shown on the Grid—Operating schedule or in another appropriate location.

Assuming a set of zero coupon tranches are required, they may be selected at this time. The variables involved may include: the year of payment, the implied interest rate on the note, and the percentage of projected available cash flow (with compounding of earlier cash flows) that will be made available to the given tier. A given tier selection row may be used, but is not required to be used. By inserting rows and copying formulas down, any number of tranches may be inserted with the remainder of the present invention to correctly recognize the requested number of tranches.

The present invention may include a Pass/Fail analysis that allows the user to regulate the tranches. This may assume that as of each payment date the performance and yield rate(s) equate to an amount exactly equal to the amounts owed. This section may also show the results of the break even analysis completed by pressing a “Calculate BE Yield” button on the schedule or through another implementation within the system of the present invention. The calculation may output the single annual rate at which each tranche of the bonds and/or other securities is fully repaid while leaving a remaining residual of $0.

The present invention may also include the ability to review the sensitivity of repayment to the compression and extension of life expectancies through the use of comparison mortality multipliers. In addition to the expected 1.0 multiplier effect to the curves, additional multipliers may be specified to either accelerate or reduce the speed of mortality and collection of death benefits. The resultant payout schedules and repayment ability reflected by the additional mortality multiplier selections may be represented graphically in a chart of annual payouts and/or reflected in a Pass/Fail analysis of the underlying tranches and security.

An administrator's “profit” from the bond and/or other securities—only portion of the transaction may be calculated after the tranches are selected. This profit may be defined as the total gross sale price of the notes/bonds and/or other securities plus any remaining residual value discounted at any given rate but defaulting to the rate of the longest duration note sold less the policy cost. The policy cost may include the NPO fee and other fees and expenses and the policy premium. Additional value from the transaction may accrue from other sources to the administrator, but these amounts have not been included.

A print macro may be included in the model to allow for various schedules to be printed using the correct maximum duration by age within the portfolio, i.e., if the youngest participant was initially 30 years old, the model will run for 70 years.

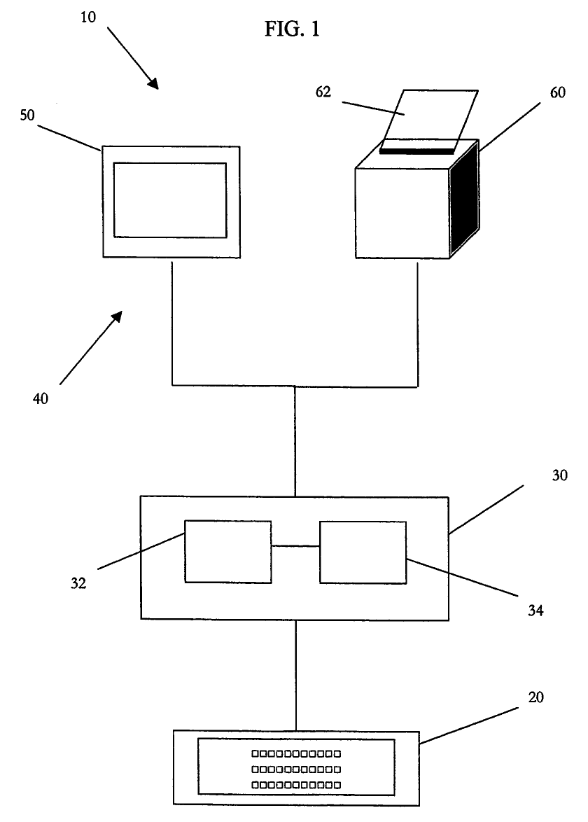

The present invention is also directed to data processing methods and systems that provide accurate and time-efficient ways of initiating, structuring and managing the above-described insurance products and techniques. FIG. 1 is a schematic illustration of exemplary data processing methods, systems and devices 10 of the present invention.

A data processing method for initiating, structuring and managing an insurance product according to the present invention may include providing a data processing device. The data processing device, for instance a general purpose computer, may include one or more of an input device 20, an output device 40, and a processing unit 30. The processing unit may further include a memory 32 and a processor 34. The input device 20 is illustrated as a keyboard; however, alternative input devices and techniques are possible, including voice recognition hardware and software, and electronic data transfer via a network connection. The memory 32 may include one or more conventional memory devices such as ROM, RAM and EEPROM devices. The memory 32 may contain data, software, executable instructions, scripts and other common memory elements or components. The processor 34 may be in communication with the memory 32. The processor 34 may function in combination with the memory 32 to, for example, retrieve data, execute calculations and other instructions, and provide control and system functions.

According to the data processing method, information from a pool of insurance applicants is entered via the input device 20. Relevant information for input is described in detail above. The processor 34 may retrieve data from the memory 32 and compare that data using instructions and/or software executed by the processor 34.

The output device 40 may generate at least one policy document 62. The output device 40 may include one or more of a visual and/or audible output device 50 (e.g., a monitor), and a printer 60. Other output devices are contemplated. For example, the output may be a conventional electronic transfer via a network connection. The policy document 62 preferably comprises cash flow and timing information.

The data processing device and method preferably outputs a result of the above method. The outputting may be performed manually or the association may be automatically executed via software or other instructions executed by the processor 34. The method may further include inputting information into the memory 32, and calculating a result. These operations may also be performed manually via the input device 20, or automatically, as described above.

While this invention is satisfied by embodiments in many different forms, as described in detail in connection with preferred embodiments of the invention, it is understood that the present disclosure is to be considered as exemplary of the principles of the invention and is not intended to limit the invention to the specific embodiments illustrated and described herein. Numerous variations may be made by persons skilled in the art without departure from the spirit of the invention. Moreover, features described in connection with one embodiment of the invention may be used in conjunction with other embodiments, even if not explicitly stated above. The scope of the invention will be measured by the appended claims and their equivalents. The abstract and the title are not to be construed as limiting the scope of the present invention, as their purpose is to enable the appropriate authorities, as well as the general public, to quickly determine the general nature of the invention. In the claims that follow, unless the term “means” is used, none of the features or elements recited therein should be construed as means-plus-function limitations pursuant to 35 U.S.C. §112, ¶6.

1. A computer program product stored in a computer useable medium for structuring at least one of bonds and other securities collateralized with one or more life insurance policies, the computer program product performing steps comprising:
receiving input regarding an appropriate grouping of insureds from a collection of one or more insureds;
receiving input regarding an initial value for (1) a face amount of one or more insurance policies, (2) one or more mortality curves for calculating a single premium, and (3) a mortality expectation table for determining a presumed mortality expectation;
receiving inputs regarding the one or more insurance policies;
receiving inputs regarding an insurer's assumptions and outcomes;
processing the inputs; and
outputting results of the processing in the form of an expected cash flow and timing.

2. The computer program product of claim 1, further comprising receiving input regarding a set of desired tranches.

3. The computer program product of claim 2, wherein the input regarding said set of desired tranches comprises information regarding a year of payment, an implied interest rate, and a percentage of projected available cash flow and portion of the projected available mortality made available to each individual tranche.

4. The computer program product of claim 3, further comprising processing said set of desired tranches and outputting an analysis of said set of desired tranches.

5. The computer program product of claim 4, wherein the processing comprises determining at least one rate of return for said set of desired tranches.

6. The computer program product of claim 1, wherein the one or more insureds consent to be insured and assign all rights in an insurance policy to at least one of a non-profit, a charitable organization, a supporting organization of the non-profit, a supporting organization of the charitable organization, and an entity with insurable interest rights.

7. A data processing system for initiating, structuring and managing at least one of bonds and other securities collateralized by one or more insurance policies, the data processing system comprising:
an input device;
wherein the input device receives input from a user regarding (1) an appropriate grouping of insureds from a collection of one or more insureds, (2) an initial value for a face amount of one or more insurance policies, (3) one or more mortality curves for calculating a single premium, (4) a mortality expectation table for calculating the presumed mortality expectation, (5) the one or more insurance policies, and (6) an insurer's assumptions and outcomes;
a data processing device comprising a processor and a memory;
wherein the data processing device accepts the input and calculates an expected cash flow and timing;
an output device; and
wherein the output device outputs the results of the calculating.

8. The data processing system of claim 7, wherein said collection of one or more insureds is an actual collection of males and females of various ages.

9. The data processing system of claim 7, wherein said collection of one or more insureds is a prospective collection of males and females of various ages.

10. The data processing system of claim 7, wherein the input device further receives input regarding separate account yields and expenses.

11. The data processing system of claim 10, wherein the separate account yields and expenses comprise a gross earning rate, an asset management fee, spread fees, and earnings outside separate account.

12. The data processing system of claim 7, wherein the insurer's assumptions and outcomes comprise variables set forth in the insurance policy structure.

13. The data processing system of claim 7, wherein the data processing device determines a value to the organization paying the premiums on the one or more insurance policies.

14. The data processing system of claim 7, wherein the input device further accepts input from the user regarding a desired set of tranches.

15. The data processing system of claim 14, wherein the data processing device further determines a break even gross earnings rate for covering repayment of said desired set of tranches with a desired residual value.

16. The data processing system of claim 14, wherein the data processing device further determines whether a given gross interest rate fully repays each debt tranche in said desired set of tranches and has a minimal residual value.

17. The data processing system of claim 14, wherein the data processing device further determines a weighted average yield of said desired set of tranches.

18. The data processing system of claim 14, wherein the data processing device further determines a complete break even rate needed to fully repay said desired set of tranches.

19. The data processing system of claim 14, wherein the input device further accepts changes to said desired set of tranches.

20. The data processing system of claim 7, wherein the calculating further comprises calculating income streams using a correlated path of equity and debt returns given a stated mix of at least one of bonds and other securities.

21. A computer program product stored in a computer useable medium for structuring at least one of bonds and other securities collateralized by one or more insurance policies, the computer program product comprising:
a module for accepting input regarding a collection of insureds;
a module for accepting input regarding insurance policy structure and variables;
a module for accepting input regarding insurance company policies and variables;
a module for accepting input regarding insurance policy beneficiary assumptions and variables;
a module for accepting input regarding a desired set of tranches;
a module for processing the inputs to determine an expected cash flow and timing; and
a module for outputting the results of the processing.

22. The computer program product of claim 21, further comprising a module for determining a break even gross earnings rate for covering repayment of said desired set of tranches with a minimal residual value.

23. The computer program product of claim 21, further comprising a module for determining a check of whether a given gross interest rate fully repays each debt tranche in said desired set of tranches and has a minimal residual value.

24. The computer program product of claim 21, further comprising a module for determining a weighted average yield of said desired set of tranches.

25. The computer program product of claim 21, further comprising a module for determining a complete break even rate needed to fully repay said desired set of tranches.

26. The computer program product of claim 21, further comprising a module for one or more mortality multipliers.
